(19) United States
(12) Patent Application Publication
(10) Pub. No.: US 2022/0234730 A1
(43) Pub. Date: Jul. 28, 2022

(54) FUSELAGE FOR TRANSPORTING MEDICAL CARGO IN AN UNMANNED AERIAL VEHICLE

(71) Applicant: The Johns Hopkins University, Baltimore, MD (US)

(72) Inventors: Jeffrey STREET, Baltimore, MD (US); Timothy AMUKELE, Baltimore, MD (US)

(73) Assignee: The Johns Hopkins University, Baltimore, MD (US)

(21) Appl. No.: 17/596,966

(22) PCT Filed: Jun. 26, 2020
(86) PCT No.: PCT/US2020/039836

§ 371 Date: Dec. 22, 2021

Related U.S. Application Data
(60) Provisional application No. 62/867,749, filed on Jun. 27, 2019.

(51) Int. Cl. B64C 39/02; B64D 9/00; B64D 1/22

(52) U.S. Cl. CPC B64C 39/024; B64D 9/003; B64D 2013/0629; B64C 2201/108; B64C 2201/128; B64D 1/22

(57) ABSTRACT

A fuselage may include abase plate including one or more attachment points for securing the base plate to an unmanned aerial vehicle, a cover removably securable to the base plate, and a cargo compartment disposed in a space between the base plate and the cover at a balance point of the unmanned aerial vehicle. Accordingly, a container to transport cargo may be positioned within the cargo compartment at the balance point of the unmanned aerial vehicle, and the cargo compartment and/or the container may include one or more devices to regulate an environment within the container (e.g., with respect to temperature, vibrations, humidity, and/or the like).

### RELATED APPLICATION

This application claims priority to U.S. Provisional Patent Application No. 62/867,749, filed on Jun. 27, 2019, the content of which is incorporated by reference herein in its entirety.

### BACKGROUND

An unmanned aerial vehicle (UAV), commonly known as a drone, is an aircraft without a human pilot aboard. The flights of UAVs can operate with various degrees of autonomy (e.g., under remote control by a human operator, autonomously by onboard computers, and/or the like). UAVs can be used for various purposes, including logistics (e.g., delivering cargo), aerial photography, data collection, combat, reconnaissance, and/or the like.

### SUMMARY

According to some implementations, a fuselage may include a base plate including one or more attachment points for securing the base plate to an unmanned aerial vehicle; a cover removably securable to the base plate; and a cargo compartment disposed in a space between the base plate and the cover at a balance point of the unmanned aerial vehicle, wherein the cover is removable from the base plate to provide access to the cargo compartment from a side of the unmanned aerial vehicle opposite from the ground.

According to some implementations, a system may include a fuselage, wherein the fuselage includes a base plate including one or more attachment points for securing the base plate to an unmanned aerial vehicle; a cover removably securable to the base plate; and a cargo compartment disposed in a space between the base plate and the cover at a balance point of the unmanned aerial vehicle, wherein the cover is removable from the base plate to provide access to the cargo compartment from a side of the unmanned aerial vehicle opposite from the ground when the unmanned aerial vehicle is on the ground. The system may further include a container to transport cargo within the cargo compartment, wherein one or more of the cargo compartment or the container includes one or more devices to regulate an environment within the container.

According to some implementations, an unmanned aerial vehicle may include a frame attached to a set of landing gear and to multiple rotors configured to lift and propel the unmanned aerial vehicle and a fuselage secured to the frame of the unmanned aerial vehicle. The fuselage may include a base including one or more attachment points for securing the base to the unmanned aerial vehicle, a cover removably securable to the base, and a cargo compartment disposed in a space between the base and the cover at a balance point of the unmanned aerial vehicle. The cover is removable from the base to provide access to the cargo compartment from a side of the unmanned aerial vehicle opposite from the landing gear. The unmanned aerial vehicle may further include one or more electronic components to monitor and control one or more environmental parameters within the cargo compartment.

Implementations generally include a device, unmanned aerial vehicle, unmanned aerial vehicle fuselage, system, method, computer program product, and/or non-transitory computer-readable medium as substantially described herein with reference to and as illustrated by the accompanying drawings and specification.

### BRIEF DESCRIPTION OF THE DRAWINGS

FIGS. 1A-1D are diagrams of one or more example implementations described herein.

FIG. 2 is a diagram of an example environment in which systems, devices, and/or methods described herein may be implemented.

FIG. 3 is a diagram of example components of one or more devices of FIG. 2.

### DETAILED DESCRIPTION

The following detailed description of example implementations refers to the accompanying drawings. The same reference numbers in different drawings may identify the same or similar elements.

Unmanned aerial vehicles (UAVs) have become prevalent, having gained significant importance and value with widespread adoption in commercial, military, consumer, and other market sectors. For example, part of the reason for the growth in popularity of UAVs, also referred to as unmanned aircraft, drones, and/or the like, is a low cost and small form factor as compared to piloted aircraft. These features also make UAVs a viable option to service communities that may be inaccessible by other vehicles (e.g., due to a lack of roads or other infrastructure). However, while UAVs can be flown for various purposes, the use of UAVs is often limited by the manner in which UAVs are designed. For example, UAVs are typically lightweight machines with multiple rotors and require precise balance to achieve a safe and stable controlled flight. Accordingly, the mass of a UAV must be precisely balanced in order to fly at all, and especially to fly efficiently. This presents significant challenges when a UAV is used to transport cargo that may have a different mass from one flight to the next, as existing UAVs are typically designed to carry payloads that do not change mass or position (e.g., cameras). Accordingly, to achieve balance, current standard practice is usually to mount the payload to a particular point of the UAV (e.g., the nose to provide the camera with a clear view) and place another heavy component (e.g., a battery) at an opposite end of the UAV as a counterweight to the payload. Consequently, if the payload mass is changed (e.g., the camera is replaced with another object that is heavier or lighter than the camera), the balance of the UAV shifts. Because small aircrafts such as UAVs are very sensitive to balance, changing the payload mass even a small amount can move the balance point enough to render the UAV unsafe, inefficient, unflyable, and/or the like.

One context in which the above-mentioned challenges may arise is when a UAV is used to transport medical cargo, such as biological samples, pharmaceuticals, and/or the like. For example, UAVs can be used to deliver and/or pick up medical cargo from remote areas, disaster areas, and/or the like, which may allow medical supplies to be delivered without having to hire a pilot, find an area to land, clear area on the ground, and/or the like. More generally, UAVs can allow biological samples, pharmaceuticals, medical devices, and/or the like to be collected at convenient locations and transported to other destinations (e.g., laboratories). However, this poses challenges because medical cargo can often be dangerous (e.g., biohazard, poisonous, controlled substances, and/or the like), and some medical cargo may have a limited lifetime. For example, whole blood specimens are generally viable for approximately eight hours from collection, and this lifetime is reduced if one or more environmental parameters are outside of the samples transport requirements (e.g., whole blood becomes inviable if boiled, frozen, or vibrated excessively, and should be maintained between 10-30° Celsius, ideally at 22° Celsius). When a UAV is used to transport medical cargo, maintaining the environmental parameter(s) within the viable range may be difficult (e.g., when the UAV is flying through a desert or cold environment, when the air is particularly moist or dry, when wind or other conditions cause vibrations, and/or the like).

Furthermore, when UAVs are used to transport medical cargo, current UAV designs present various accessibility challenges. For example, UAVs carrying medical cargo are often flown between a central hub (e.g., a hospital, a warehouse, a laboratory, and/or the like) and outlying sites (e.g., a clinic and/or the like). At both locations, non-aviation personnel (e.g., nurses, lab technicians, and/or the like) may need to interact with the UAV to load and/or unload the cargo and change batteries after each flight. However, UAVs typically require extensive training to operate and may be difficult to service for non-aviation personnel, as many UAVs locate cargo and battery compartments underneath the aircraft, which tends to be hard to access. For example, the UAV would need to be picked up off the ground and turned over or placed on some kind of stand up in the air to access the cargo and battery compartments underneath, which can be tedious and potentially impossible in certain environments (e.g., where there is no infrastructure). Furthermore, many UAVs require tools to open service compartments, which increases the inconvenience, difficulty, and inaccessibility for non-aviation personnel, especially when the UAV has separate cargo and battery compartments (e.g., to maintain balance).

Some implementations described herein relate to a fuselage structure including a cargo compartment that may be positioned at a balance point (e.g., a center of mass) to which the fuselage structure is secured. For example, the fuselage structure may include a base plate with one or more attachment points for securing the fuselage to the UAV, a bottom portion that is secured to the base plate and the UAV from underneath the UAV (e.g., a same side as landing gear of the UAV, a ground side when the UAV is on the ground, and/or the like), and a cover that can be secured to the base plate without the use of tools or small parts (e.g., pins or screws, and/or the like). Furthermore, the cover may be removable from above the UAV (e.g., a side of the UAV opposite to the landing gear, the ground, and/or the like), and a space between the cover and the base plate may define the cargo compartment for carrying a payload to be transported by the UAV, which makes the cargo compartment accessible from above the UAV. In addition, the base plate may include a cavity to house a battery that powers the UAV, whereby the cavity to house the battery may also be accessed through the cargo compartment when the cover is removed.

In this way, because the cargo compartment is provided at the balance point of the UAV, a mass of the aircraft is distributed in such a way that mass can be added to and/or removed from the cargo compartment without affecting balance of the UAV. Furthermore, because the cover can be removed from above the UAV without the use of tools, small parts, and/or the like, the cargo compartment and the cavity that houses the battery can be easily accessed to load and/or unload cargo from the cargo compartment, change batteries, and/or the like after a flight in which the UAV arrives at a destination and/or before a flight in which the UAV travels to a next destination. In addition, as described in further detail elsewhere herein, the fuselage and/or a container to be transported in the fuselage may include one or more environmental regulation mechanisms to maintain the cargo within a range of one or more parameters that relate to temperature, vibrations, humidity, and/or the like. Furthermore, the fuselage and/or the container to be transported in the fuselage may include one or more containment mechanisms to prevent the cargo from leaking, seeping, and/or otherwise escaping the container in case the UAV crashes, experiences a hard landing, and/or the like. In this way, the containment mechanisms may allow the fuselage and/or the container transported in the fuselage to be used to transport medical cargo that may include biohazardous material, poisonous substances, controlled substances, and/or the like, and the environmental regulation mechanisms may preserve the quality of the medical cargo during transport via the UAV.

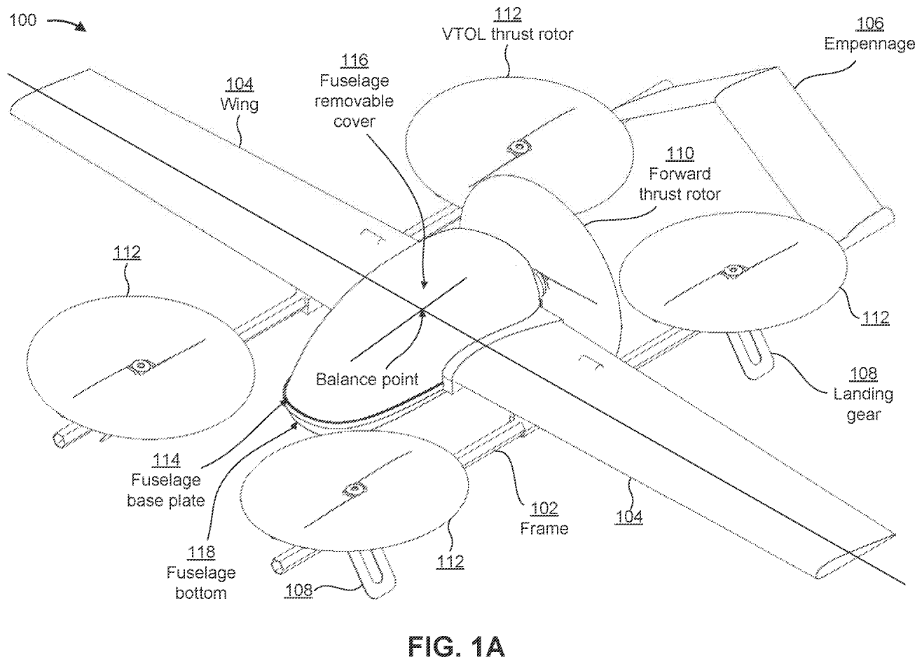

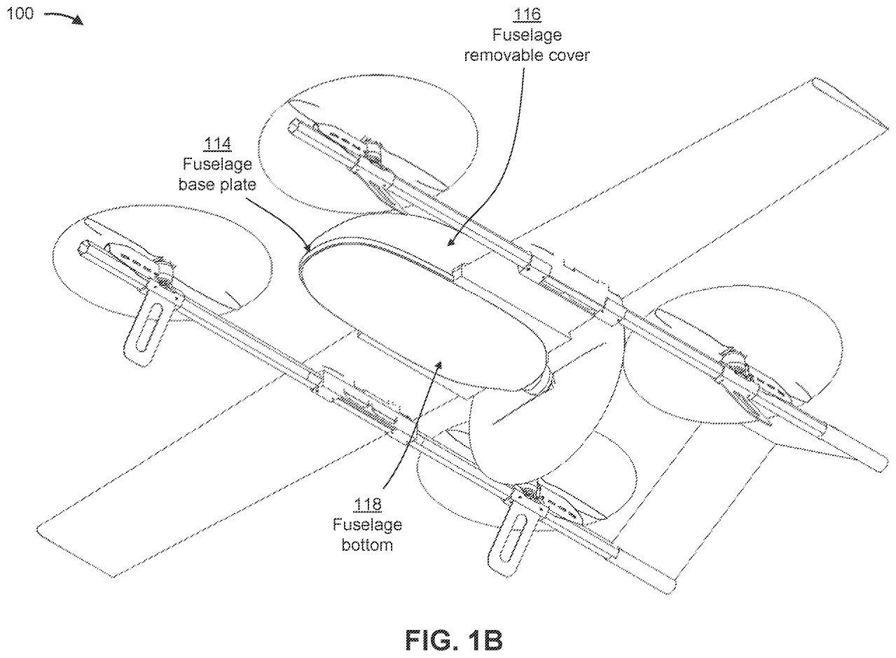

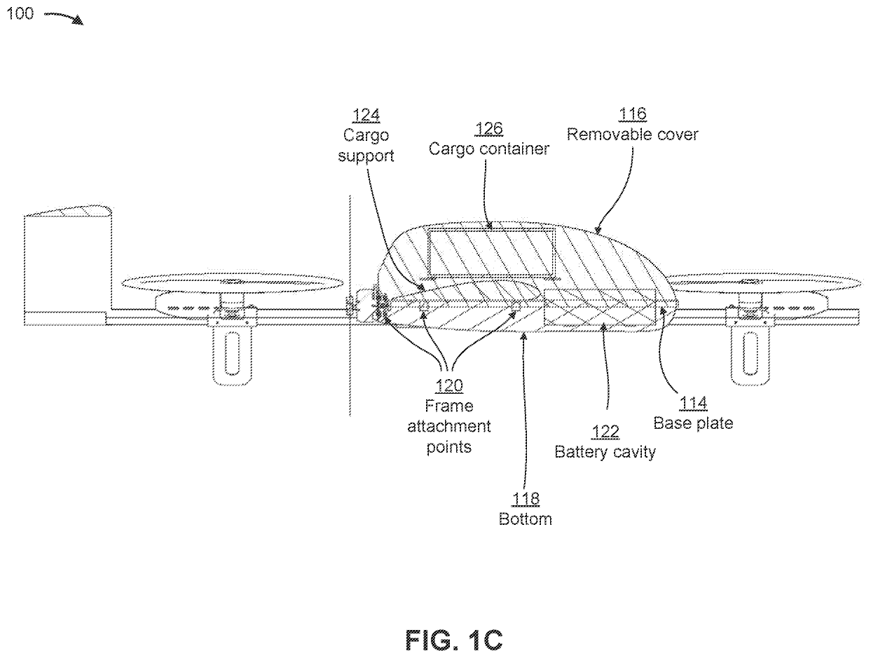

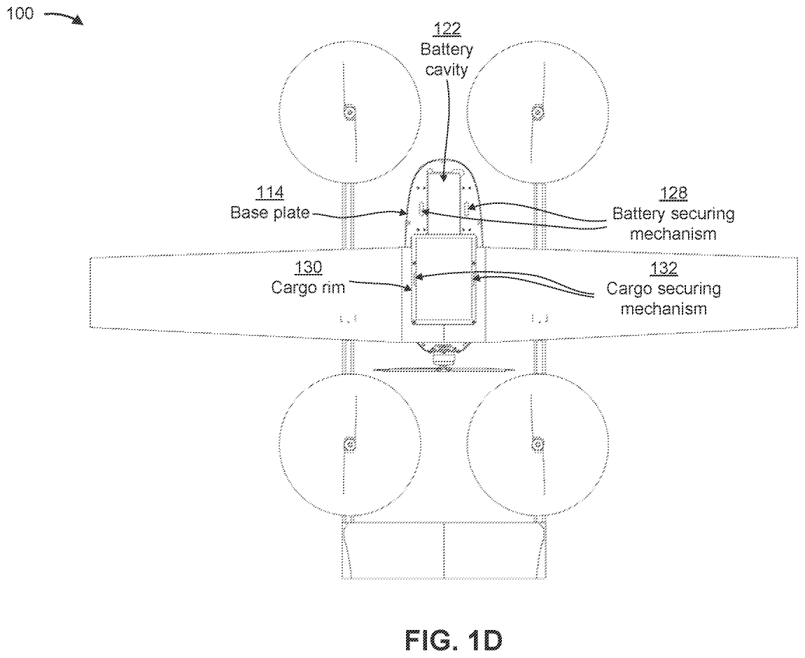

FIGS. 1A-1D are diagrams of one or more example implementations 100 described herein. As shown in FIGS. 1A-1B, a fuselage structure may include a base plate 114, a removable cover 116, and a bottom portion 118. As further shown in FIG. 1C, a space between the base plate 114 and the removable cover 116 may define a cargo compartment or cargo compartment where a cargo container 126 can be placed to transport a payload. In addition, the base plate 114 may include a battery cavity 122 to house a battery that powers a UAV to which the fuselage structure is secured, and a space between the base plate 114 and the bottom portion 118 may be used to house various electronic components associated with the UAV (e.g., autopilot electronics, various wires and interconnects, power supply cables, and/or the like). As further shown in FIG. 1D, interior components of the fuselage structure may further include a battery securing mechanism 128 for securing a battery within the battery cavity 122, a cargo rim 130 and/or cargo securing mechanism 132 for securing the cargo container 126, and/or the like.

As shown in FIG. 1A, the UAV in example implementation(s) 100 may be an unmanned vertical take-off and landing (VTOL) aircraft that has a frame 102, fixed wings 104, and a tail assembly or empennage 106. As further shown in FIG. 1A, the UAV includes landing gear 108 attached to the frame 102. The fixed wings 104 are secured to the frame 102 to form a fixed-wing airframe. In some implementations, the frame 102 may provide structural support for motors associated with various rotors that are used to fly the UAV, which may include a forward thrust rotor 110 and various VTOL thrust rotors 112, as described in further detail elsewhere herein. In some implementations, the landing gear 108 may be sufficiently strong to support a maximum load weight for a combination of the components of the UAV and, in some cases, one or more components and/or objects housed within the fuselage structure (e.g., a payload, a battery, internal support components, sensors, electronic components, and/or the like).

In example implementation(s) 100, the fixed wings 104 are airfoils that produce lift to facilitate aircraft flight. During flight, air passing over the fixed wings 104 creates a region of lower-than-normal air pressure over top surfaces of the fixed wings 104, with a higher pressure existing on bottom surfaces of the fixed wings 104. This results in a net upward force acting on the fixed wings 104 to generate lift. In some implementations, fixed wings 104 may include a pair of wings that are applied to and extend from opposite sides of the fuselage structure (e.g., in implementations where the fuselage structure and the UAV are manufactured as a single integrated unit). Additionally, or alternatively, the fixed wings 104 may include a single structure. For example, the fuselage structure and the UAV may be separate modules, with the fuselage structure attaching to the fixed wings 104, a portion of the frame 102, and/or the like. Although not shown, the fixed wings 104 may include ailerons that are pivotally retained at rears of the fixed wings 104 near outer or distal extremities of the fixed wings 104. In some implementations, the empennage 106 gives stability to the UAV, and is located behind and in spaced-apart relation to the trailing extremity of the fuselage structure. For example, as shown, the empennage 106 may be a V-shaped tail assembly that stabilizes the UAV during flight.

As shown in FIG. 1A, the UAV may be a hybrid aircraft including separate rotors for forward and vertical thrust. In particular, the UAV may have a hybrid quadrotor “X” configuration, including a forward thrust rotor 110 mounted to a rear extremity of the fuselage structure in front of empennage 106. The forward thrust rotor 110, which provides forward thrust to the UAV, may be powered by a forward propulsion engine, sometimes referred to as a main engine. While the example UAV shown in FIG. 1A uses a single forward thrust rotor 110 mounted at the rear of the fuselage structure, in other designs the UAV may include one or multiple thrust rotors mounted at other positions.

As further shown in FIG. 1A, the UAV includes a VTOL propulsion system, or simply a VTOL system, to provide vertical thrust for vertical takeoff and landing operations. For example, in FIG. 1A, the VTOL propulsion system includes four VTOL thrust rotors 112 in a quadrotor “X” pattern for providing vertical lift and yaw control over the UAV. Additionally, or alternatively, the UAV may include a different quantity of VTOL thrust rotors 112 and/or VTOL thrust rotors 112 at different locations. Furthermore, in some implementations, the VTOL thrust rotors 112 may be fixed-mount or pivot-mount rotors. Forward thrust engines and vertical thrust engines used to power the forward thrust rotor 110, the VTOL thrust rotors 112, and/or the like can be internal combustion engines, electric (e.g., battery-powered) motors, and/or the like.

In some implementations, the fuselage structure may be used to transport medical cargo, which may include hazardous or sensitive cargo (e.g., biological samples, poisonous substances, controlled substances, and/or the like) that may need to be contained in the event of a crash, a hard landing, and/or the like. For example, if the medical cargo transported within the fuselage structure includes a blood specimen that is known or suspected to be infected with a virus (e.g., Ebola), the fuselage structure and/or a container to be transported within the fuselage structure may be designed to contain the medical cargo in the event of a crash or hard landing to ensure that the virus remains inside and cannot escape the container. Furthermore, the fuselage structure and/or the container to be transported within the fuselage structure may include one or more environmental monitoring and/or control mechanisms to maintain the cargo in a viable condition during transport. For example, in some cases, the medical cargo may be a blood sample or other cargo that needs to stay warm, while in other cases the medical cargo may need to stay cold. In other words, depending on the nature of the cargo, external environmental variables (e.g., whether the UAV is flying in hot or cold weather, windy conditions, and/or the like), and/or the like, the medical cargo may need to be maintained within a certain range of one or more parameters with respect to temperature, vibration, humidity, and/or the like. Accordingly, as described in further detail elsewhere herein, the environmental monitoring and/or control mechanisms may include a thermoelectric cooler, an air conditioner, a heater, a heating and/or cooling insert, a temperature sensor (e.g., a thermometer), a shock absorber, a vibration dampener, an active vibration control device, a vibration sensor (e.g., a piezoelectric sensor, an accelerometer, a gyroscope), a humidifier, a dehumidifier, a humidor, a passive humidity control pack, a humidity sensor, and/or the like.

In some implementations, because the fuselage structure is designed to carry medical cargo that may have a different mass from one flight to another, the fuselage structure may be designed to position a cargo compartment at a balance point of the UAV. For example, the UAV is a small aircraft that is very sensitive to balance, whereby the UAV may become unflyable if not properly balanced. Accordingly, as shown in FIGS. 1A-1B, the fuselage structure is positioned with the cargo compartment at the balance point (e.g., center of mass) of the UAV, which allows the cargo carried in the cargo compartment to be loaded, unloaded, and/or the like without affecting the overall balance of the UAV. Notably, in some implementations, the balance point or center of mass may not necessarily be the mid-point of the UAV, as different components of the UAV may affect the balance of UAV differently due to having different masses, weights, and/or the like.

For example, in some implementations, the UAV may have a balance point or center of mass that corresponds to an intersection between a midline of the UAV that extends from the nose of the fuselage structure to empennage 106 and a perpendicular line defining an equal distribution of weight or mass between the front and rear of the UAV. In the example shown in FIG. 1A, the balance point is at a point somewhat closer to the front of the UAV (e.g., based on the extra weight of the forward thrust rotor 110 and empennage 106). Furthermore, in some cases, other variables may affect the balance point of the UAV (e.g., an amount of fuel in a tank in cases where the UAV is powered at least in part by one or more internal combustion engines). Accordingly, in some implementations, the precise balance point or center of mass of the UAV may be determined (e.g., at a manufacture or design stage) under various conditions, including when there is no cargo, fuel, battery, and/or the like in the UAV, and the fuselage structure may be secured to the UAV with the cargo compartment positioned at the precise balance point based on the conditions in which the UAV is to fly. In this way, the balance of the UAV may be unaffected by any variations in the mass of the cargo transported within the cargo compartment, as the cargo compartment within the fuselage structure is aligned with the precise balance point of the UAV.

As further shown in FIGS. 1A-1B, the cover 116 of the fuselage structure is removable from the base plate 114 and/or the bottom portion 118 from above the UAV (e.g., a side opposite the landing gear 108), which provides easy access to the interior of the fuselage structure. In particular, the base plate 114 and bottom portion 118 of the fuselage structure may be permanently or semi-permanently secured to the frame 102 of the UAV (e.g., the base plate 114 and bottom portion 118 may be integrated with the frame 102 of the UAV, attached to the frame 102 of the UAV via one or more screws, and/or the like), and the removable cover 116 may be firmly yet removably secured to the base plate 114. For example, in some implementations, the base plate 114 may be formed from metal or another magnetic material, and the removable cover 116 of the fuselage structure may include a set of magnets that are disposed at one or more locations around an exterior rim of the removable cover 116. Accordingly, the magnets may firmly secure the cover 116 to the base plate 114 while also allowing the cover 116 to be easily removed to access the interior of the fuselage structure (e.g., the magnets may be rare-earth magnets that produce a strong magnetic field to ensure that the cover 116 does not separate from the base plate 114 during transport). Additionally, or alternatively, the cover 116 may be removably secured to the base plate 114 via other suitable mechanisms, such as a snap latch, a metal clasp, a carabiner, a shackle, and/or the like. In any case, the cover 116 is removable from above the UAV (i.e., a side opposite the landing gear 108) without the use of tools or small parts that could be easily lost or misplaced, which may allow non-aviation personnel to easily access the cargo, battery, and/or other components and/or objects in the fuselage structure.

As shown in FIG. 1C, the fuselage structure includes one or more frame attachment points 120 for securing the base plate 114 and the bottom portion 118 to the UAV. For example, as mentioned above, the base plate 114 and the bottom portion 118 may be integrated with the UAV, in which case the frame attachment points 120 may be points where the base plate 114 and/or bottom portion 118 are welded to the UAV. Additionally, or alternatively, the fuselage structure may be constructed as a separate module that can be secured to the UAV, and the frame attachment points 120 may include openings to screw or otherwise fasten the base plate 114 and/or bottom portion 118 to the UAV. In this case, the base plate 114 and/or bottom portion 118 may be detached from the UAV and replaced if there is damage to either or both components. Furthermore, as shown in FIG. 1C, there may be a space between a lower surface of the base plate 114 and the bottom portion 118, and various electronic components of the UAV may be housed in that space. For example, the electronic components housed in the space between the lower surface of the base plate 114 and the bottom portion 118 may include autopilot electronics, wiring, circuit boards, processors, communication modules, interfaces to connect to servo motors that operate rudders and other components of the UAV, connectors to interface with environmental regulation and/or containment components in the cargo compartment, and/or the like. Accordingly, the electronic components housed in the space between the lower surface of the base plate 114 and the bottom portion 118 may interface with various sensors, actuators, and/or the like that are used to monitor and maintain one or more environmental parameters during flight, and may enable the environmental parameter(s) to be remotely monitored and/or controlled via one or more ground stations. Furthermore, by housing the electronic components in the space between the lower surface of the base plate 114 and the bottom portion 118, the electronic components may be protected from inadvertent damage when personnel remove the cover 116 to access the interior of the fuselage structure.

As further shown in FIG. 1C, the base plate 114 may include a battery cavity 122 to house a battery that powers the UAV, certain electronic components of the UAV, and/or the like. In this way, when the UAV arrives at a destination, personnel who remove the cover 116 from the base plate 114 may easily access the battery within the battery cavity 122 (e.g., to recharge the battery, swap out the battery for a fully charged battery, and/or the like).

As further shown in FIG. 1C, the interior of the fuselage structure may further include a cargo compartment, which may include a cargo support 124 to hold a cargo container 126 in which cargo to be transported is placed. For example, the cargo support 124 may include an elevated surface to hold and protect the cargo container 126. Furthermore, in some implementations, the cargo support 124 may be constructed in a way to absorb vibrations, impact shock, and/or the like to prevent vibrations from transferring to the cargo held in the cargo container 126. Additionally, or alternatively, as described in further detail elsewhere herein, the cargo support 124, the cargo container 126, and/or the like may be equipped with one or more environmental regulation and/or containment mechanisms to preserve and/or contain the cargo carried in the cargo container 126 during transport, after a crash or hard landing, and/or the like.

As further shown in FIG. 1D, the battery cavity 122 may be associated with a battery securing mechanism 128 to securely hold a battery within the battery cavity 122 during flight and to allow the battery to be easily removed from the battery cavity 122. For example, in FIG. 1D, the battery securing mechanism 128 includes a pair of slots on either side of the battery cavity 122, and a tensioning mechanism such as a strap with hook-and-loop fasteners may pass through the pair of slots to hold the battery in place. Additionally, or alternatively, the tensioning mechanism used to hold the battery in place may be a rubber strap with hooks on one or both ends, and the hooks may be formed to grasp one or both slots on either side of the battery cavity 122. In some implementations, the battery securing mechanism 128 may employ a self-tensioning mechanism to alleviate personnel having to tension the battery into place.

As further shown in FIG. 1D, the cargo compartment may include a cargo rim 130 to surround the cargo container 126 and act as a fence-like barrier to hold the cargo container in place. For example, the battery cavity 122 can be formed in the base plate 114 to securely hold the battery in place because the battery may generally have a well-defined and/or standardized form factor. In contrast, the cargo container 126 may have a variable size to accommodate cargos of varying sizes, whereby the cargo support 124 is constructed as a plate or support member to accommodate different sizes for the cargo container 126. Accordingly, the cargo rim 130 may surround and hold the cargo container 126 in place, and in some cases, the cargo rim 130 may be adjustable to provide a tighter fit around the cargo container 126. For example, in some implementations, the cargo rim 130 may be constructed with one or more walls that can be moved inward or outward to accommodate different sizes for the cargo container 126.

As further shown in FIG. 1D, the cargo compartment may also include a cargo securing mechanism 132 for holding the cargo container 126 in place. For example, the cargo securing mechanism 132 may have a similar design as described above with respect to the battery securing mechanism 128. Additionally, or alternatively, the cargo securing mechanism 132 may be designed to accommodate different sizes for the cargo container 126, amorphous cargo that is transported without a container, and/or the like. For example, the cargo securing mechanism 132 may be a strap with hook-and-loop fasteners to hold the cargo in place through tension, a rubber strap with one end permanently secured to the UAV, the base plate 114, and/or the like with a hook, loop, carabiner, and/or the like at the other end. In other examples, the cargo securing mechanism 132 may be a mesh or web netting, a collection of bungees with hooks, and/or another mechanism to hold the cargo in place regardless of whether the cargo is transported in a cargo container 126.

In some implementations, as mentioned above, the fuselage structure may be designed to carry medical cargo or other cargo that is sensitive to variations in one or more environmental parameters such as temperature, vibration, humidity, and/or the like. Furthermore, because medical cargo is often hazardous and/or dangerous, the cargo may need to be contained in the event of a crash, hard landing, and/or the like. Accordingly, as described herein, the fuselage structure and/or the cargo container 126 may be designed to enable the environmental parameter(s) within the cargo compartment to be monitored and/or controlled and to prevent the cargo transported within the cargo compartment from escaping the cargo container 126.

For example, different temperature-control mechanisms can be implemented in different cases because cargo may have different temperature requirements (e.g., whole blood should generally be maintained between 10-30° Celsius, and ideally at 22° Celsius, but other biological samples, pharmaceuticals, and/or the like may need to be maintained at cold or frozen temperatures). In some cases, the temperature-control mechanism(s) may further vary depending on external conditions. For example, an ambient temperature may vary depending on whether the UAV is flying in the desert, in the winter, and/or the like. Accordingly, the temperature-control mechanisms may generally be designed to maintain temperature within a desired range, which may be at, below, or above ambient temperature, body temperature, and/or the like.

For example, in some implementations, the temperature-control mechanism may include a passive temperature control mechanism, such as a frozen cooler insert that is placed in an insulated container to maintain a cold temperature, a warming insert that may be activated and placed in an insulated container to maintain a warm temperature, and/or the like. Accordingly, in some implementations, the cargo container 126 to be transported within the fuselage structure may include insulation and/or an area (e.g., one or more slots, openings, and/or the like) for receiving the passive cooling and/or heating inserts in order to maintain an environment within the cargo container 126 within a desired range. Additionally, or alternatively, the temperature control mechanism may include an active temperature control mechanism, such as a thermoelectric cooler (TEC) that can be operated to transfer heat in multiple directions to either heat or cool an environment. For example, the TEC may be housed within the cargo container 126, in the cargo compartment external to the cargo container 126, and/or the like, and the TEC may be operated in a first mode to cool the cargo container 126 or in a second mode to warm or heat the cargo container 126 (e.g., by reversing a voltage supplied to the IEC). Furthermore, in some implementations, the cargo container 126 and/or the interior of the fuselage structure may be provided with one or more sensors to measure a temperature within the cargo compartment, within the cargo container 126, and/or the like. In a similar respect, as mentioned elsewhere herein, the cargo container 126 and/or the interior of the fuselage structure may interface with electronics of the UAV to enable remote monitoring of the temperature within the cargo compartment, within the cargo container 126, and/or the like and/or to enable remote control of the temperature within the cargo compartment, within the cargo container 126, and/or the like.

In some implementations, one or more vibration mitigations may also be implemented within the fuselage structure to absorb, dampen, and/or otherwise control vibrations that may compromise quality of the cargo to be transported within the fuselage structure. In particular, the vibration mitigation mechanisms may include passive vibration mitigation mechanisms, such as passive cushioning or isolation mechanisms to absorb vibrations, impact shock, and/or the like. For example, the passive vibration mitigation mechanisms may include an anti-vibration pad, spherical or semi-spherical vibration damping balls, pneumatic or air isolators (e.g., bladders of compressed air), bubble wrap, and/or the like. Additionally, or alternatively, the vibration mitigation mechanisms may include one or more vibration mitigation mechanisms that are designed to apply a force equal and opposite to external vibrations in order to neutralize the external vibration. Furthermore, in some implementations, the cargo support 124 may be arranged to mitigate vibrations by absorbing and/or counteracting external vibrations (e.g., due to wind, turbulence, a transition from a flight mode to a ground mode, and/or the like). Furthermore, in some implementations, the cargo container 126 and/or the interior of the fuselage structure may be provided with one or more sensors to measure vibrations within the cargo compartment, within the cargo container 126, and/or the like. In a similar respect, the cargo container 126 and/or the interior of the fuselage structure may interface with electronics of the UAV to enable remote monitoring of the vibrations within the cargo compartment, within the cargo container 126, and/or the like and/or to enable remote control of the vibration mitigation mechanisms implemented within the fuselage structure, the cargo container 126, and/or the like.

In some implementations, the fuselage structure, the cargo container 126, and/or the like may be further designed to maintain a humidity within the cargo container 126 within a desired range. For example, the humidity control mechanisms may include a passive humidity control mechanism such as a two-way humidity control pack arranged to remove moisture from an environment and/or add moisture to the environment in order to maintain humidity at a certain level. In other examples, the humidity control mechanisms may include an active humidity control mechanism, such as a humidor, a humidifier/dehumidifier, and/or the like. Furthermore, in some implementations, the cargo container 126 and/or the interior of the fuselage structure may be provided with one or more sensors to measure a humidity within the cargo compartment, within the cargo container 126, and/or the like. In a similar respect, the cargo container 126 and/or the interior of the fuselage structure may interface with electronics of the UAV to enable remote monitoring and/or control of the humidity within the cargo compartment, within the cargo container 126, and/or the like and/or to enable remote control of the humidity control mechanisms implemented within the fuselage structure, the cargo container 126, and/or the like.

In some implementations, the cargo container 126, the fuselage structure, and/or the like may further include padding, wrapping, insulation, and/or materials that are made from absorbent materials to contain any leakage seeping from the medical cargo that may be transported within the fuselage structure. For example, the cargo container 126 may include padding constructed from a cotton and/or gauze material. Protective wrapping may also be positioned within the cargo container 126 to surround the medical cargo being transported via the UAV. The protective wrapping may provide an insulating barrier between the medical cargo and an inner surface of the cargo container 126. The protecting wrapping may also be constructed of a shock-absorbent material, which limits the movement of the medical cargo within the cargo container 126. Furthermore, the cargo container 126 may include insulation that serves multiple purposes, including passive temperature control, vibration mitigation by being constructed of a shock-absorbent material sized to fully occupy and fit snugly within the cargo container 126, and/or the like. In some implementations, the insulation may be constructed from an expanded or expandable flexible polyurethane foam. In this way, the insulation may tightly envelop the medical cargo carried in the cargo container, maintain a temperature of the medical cargo within a desired range, and provide a degree of shock-absorbency or vibration mitigation.

In some implementations, as mentioned above, the various environmental regulation mechanisms and/or containment mechanisms may interface with onboard electronics of the UAV to enable onboard and/or remote monitoring and/or control of the environment within the cargo container 126. For example, the UAV may include a microcontroller-based feedback control system that can read in measurements from one or more environmental sensors (e.g., with respect to temperature, vibrations, humidity, and/or the like), which may be placed inside the cargo container 126, outside the cargo container 126, and/or other suitable locations. For example, one or more sensors may be placed on a hot side of the TEC, on a cold side of the TEC, outside to measure ambient temperature, and/or the like, and temperature measurements may be monitored to ensure that the TEC does not overheat or malfunction, to ensure that temperature remains within the desired range, and/or the like. For example, if a difference between a temperature inside the cargo container 126 and a temperature outside the cargo container 126 satisfies a threshold, then voltage supplied to the TEC may be increased to maintain the temperature inside the cargo container 126. On the other hand, if the difference between the temperature inside the cargo container 126 and outside the cargo container 126 does not satisfy the threshold, the TEC may be run as normal (e.g., at a lower current or voltage level).

Accordingly, in some implementations, measurements from one or more environmental sensors may be stored in a memory (e.g., for logging purposes) and/or provided to one or more onboard and/or remote devices to enable remote monitoring of the environment within the cargo container 126. In some cases, where the environmental regulation mechanisms include one or more active environmental regulation mechanisms, the interface with the onboard and/or remote devices may further enable control over the active environmental regulation mechanisms to maintain the temperature, vibrations, humidity, and/or other environmental parameters within the appropriate range for the particular medical cargo being transported.

In some implementations, in addition to providing various mechanisms to control one or more environmental parameters and/or contain the cargo transported within the cargo container 126, one or more security measures may be implemented by the cargo container 126 to prevent unauthorized parties from gaining access to medical cargo that may potentially be dangerous, hazardous, poisonous, controlled, and/or the like. For example, the cargo container 126 may include one or more locking mechanisms, while minimal or no security may be implemented at a level of the removable cover 116. In this way, the cargo container 126 can easily be passed from courier to courier (e.g., from a car to a motorcycle to the UAV and then to another car and/or the like) without requiring personnel to keep track of keys, combinations, security codes, and/or the like to remove and/or secure the removable cover 116. Furthermore, implementing physical security measures at the level of the removable cover 116 (e.g., more robust material, locks and keys, and/or the like) may introduce additional weight to the fuselage structure, which may raise difficulties with respect to flying the UAV because UAVs tend to be very sensitive to weight.

As indicated above, FIGS. 1A-1D are provided merely as one or more examples. Other examples may differ from what is described with regard to FIGS. 1A-1D. For example, while implementation(s) 100 are described herein in a context in which the fuselage structure is secured to a UAV having a hybrid quadrotor configuration, the fuselage structure can be integrated with a UAV and/or constructed as a separate module to be secured to a UAV having any suitable configuration. For example, the UAV may be an unmanned fixed-wing aircraft, an unmanned helicopter, an unmanned multi-rotor aircraft (e.g., a quadcopter), a hybrid unmanned aircraft, and/or the like. Furthermore, FIGS. 1A-1D illustrate various implementations of the fuselage structure, the UAV, and/or the like from different viewing angles. Although the accompanying descriptive text may use terms such as “top,” “above,” “bottom,” “underneath,” “side,” and/or the like in reference to such viewing angles, such references are merely descriptive and do not imply or require that the fuselage structure, the UAV, and/or the like be implemented or used in a particular spatial orientation unless explicitly stated otherwise.

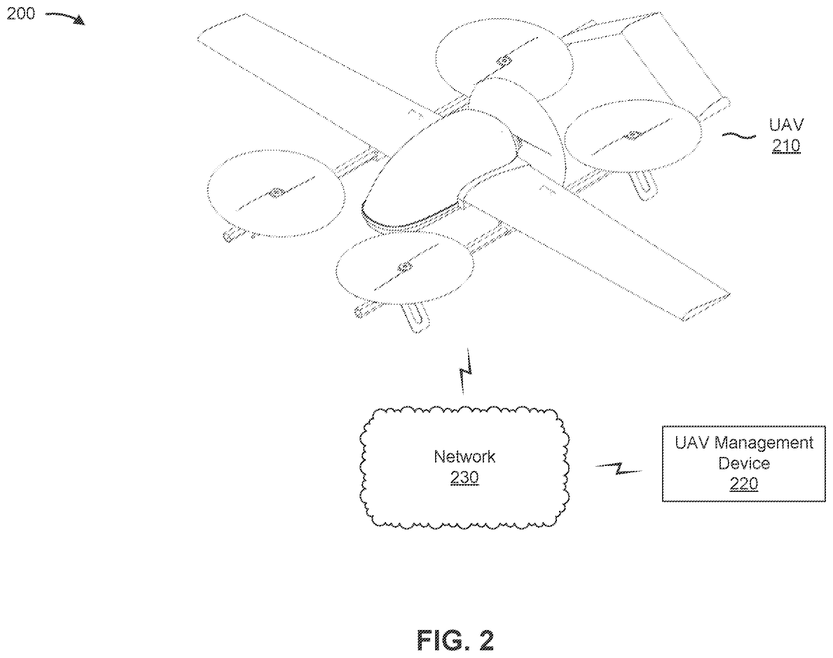

FIG. 2 is a diagram of an example environment 200 in which systems and/or methods described herein may be implemented. As shown in FIG. 2, environment 200 may include an unmanned aerial vehicle (UAV) 210, a UAV management device 220, and a network 230. Devices of environment 200 may interconnect via wired connections, wireless connections, or a combination of wired and wireless connections.

UAV 210 includes an aircraft without a human pilot aboard, and can also be referred to as an unmanned aircraft (UA), an unmanned aircraft system (UAS), a drone, a remotely piloted vehicle (RPV), a remotely piloted aircraft (RPA), a remotely operated aircraft (ROA), and/or the like. UAV 210 can have various shapes, sizes, configurations, characteristics, and/or the like for various purposes and applications. In some implementations, UAV 210 can include one or more sensors, such as a biological sensor, a temperature sensor, a chemical sensor, a humidity sensor, a vibration sensor, an electromagnetic spectrum sensor (e.g., a visual spectrum, infrared or near infrared cameras, radar systems, and/or the like), and/or the like. In some implementations, UAV 210 can include one or more components for communicating with UAV management device 220 via network 230 (e.g., an LTE communications component, a wireless local area network (WLAN) communications component, a satellite communications component, and/or the like). For example, UAV 210 can transmit information to and/or receive information from UAV management device 220, such as sensor data, environmental control data, flight plan information, and/or the like.

UAV management device 220 includes one or more devices for managing UAV 210, managing a flight plan for UAV 210, monitoring and/or controlling one or more environmental parameters associated with a payload (e.g., medical cargo) being transported by UAV 210, and/or the like. For example, UAV management device 220 can include a server, a desktop computer, a laptop computer, or a similar device. In some implementations, UAV management device 220 can communicate with UAV 210 via network 230 to receive information related to one or more environmental parameters associated with the payload being transported by UAV 210 and/or transmit information to control the one or more environmental parameters associated with the payload being transported by UAV 210. In some implementations, UAV management device 220 can permit control of UAV 210 by a user who interacts with UAV management device 220 via one or more input and/or output devices. In some implementations, UAV management device 220 can be included in a data center, a cloud computing environment, a server farm, and/or the like.

Network 230 includes one or more wired and/or wireless networks. For example, network 230 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

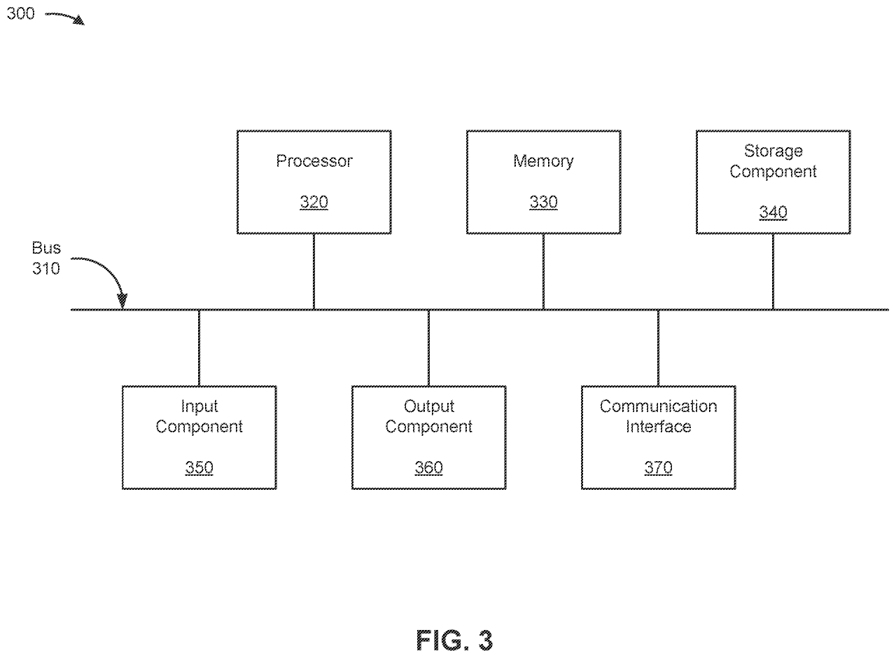

FIG. 3 is a diagram of example components of a device 300. Device 300 may correspond to UAV 210, UAV management device 220, and/or the like. In some implementations, UAV 210, UAV management device 220, and/or the like may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among multiple components of device 300. Processor 320 is implemented in hardware, firmware, and/or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a component for determining location (e.g., a global positioning system (GPS) component) and/or a sensor (e.g., an accelerometer, a gyroscope, an actuator, another type of positional or environmental sensor, and/or the like). Output component 360 includes a component that provides output information from device 300 (via, e.g., a display, a speaker, a haptic feedback component, an audio or visual indicator, and/or the like).

Communication interface 370 includes a transceiver-like component (e.g., a transceiver, a separate receiver, a separate transmitter, and/or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. As used herein, the term “computer-readable medium” refers to a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A fuselage, comprising:
a base plate including one or more attachment points for securing the base plate to an unmanned aerial vehicle;
a cover removably securable to the base plate; and
a cargo compartment disposed in a space between the base plate and the cover at a balance point of the unmanned aerial vehicle,
wherein the cover is removable from the base plate to provide access to the cargo compartment from a side of the unmanned aerial vehicle opposite from the ground.

2. The fuselage of claim 1, wherein the cargo compartment includes a cargo support and a raised rim to surround a container holding cargo to be transported via the unmanned aerial vehicle.

3. The fuselage of claim 2, wherein the cargo compartment further includes one or more tensioning mechanisms for securing the container to the cargo support.

4. The fuselage of claim 1, wherein the base plate includes a cavity to house a battery that powers the unmanned aerial vehicle, and
wherein the cavity to house the battery is accessible through the cargo compartment when the cover is removed from the base plate.

5. The fuselage of claim 4, wherein the base plate includes one or more tensioning mechanisms for securing the battery within the cavity.

6. The fuselage of claim 1, wherein the cover is removably securable to the base plate via one or more magnets.

7. The fuselage of claim 1, further comprising:
a bottom portion secured to the base plate and the unmanned aerial vehicle from underneath the unmanned aerial vehicle,
wherein one or more electronic components of the unmanned aerial vehicle are housed in an area between the base plate and the bottom portion of the fuselage.

8. The fuselage of claim 7, further comprising:
an interface between the one or more electronic components and one or more sensors and actuators to monitor and control one or more environmental parameters within the cargo compartment.

9. The fuselage of claim 7, wherein the base plate and the bottom portion are integrated into a structure of the unmanned aerial vehicle.

10. A system, comprising:
a fuselage, wherein the fuselage includes:
a base plate including one or more attachment points for securing the base plate to an unmanned aerial vehicle;
a cover removably securable to the base plate; and
a cargo compartment disposed in a space between the base plate and the cover at a balance point of the unmanned aerial vehicle,
wherein the cover is removable from the base plate to provide access to the cargo compartment from a side of the unmanned aerial vehicle opposite from the ground when the unmanned aerial vehicle is on the ground; and
a container to transport cargo within the cargo compartment,
wherein one or more of the cargo compartment or the container includes one or more devices to regulate an environment within the container.

11. The system of claim 10, wherein the one or more devices include a thermoelectric cooler to maintain the environment at a temperature within a desired range.

12. The system of claim 10, wherein the container includes one or more of insulation or an area for receiving a passive heating or passive cooling insert to maintain the environment at a temperature within a desired range.

13. The system of claim 10, wherein the one or more devices include one or more passive cushioning or isolation mechanisms to absorb one or more of vibrations or impact shock.

14. The system of claim 10, wherein the one or more devices include an active vibration control to apply a force equal and opposite to external vibrations.

15. The system of claim 10, wherein the one or more devices include a humidity controller to add moisture to or remove moisture from the environment within the container.

16. The system of claim 10, further comprising:
an interface to one or more electronic components associated with the unmanned aerial vehicle to enable one or more of onboard or remote monitoring of the environment.

17. An unmanned aerial vehicle, comprising:
a frame attached to a set of landing gear and to multiple rotors configured to lift and propel the unmanned aerial vehicle;
a fuselage secured to the frame of the unmanned aerial vehicle, wherein the fuselage includes:
a base including one or more attachment points for securing the base to the unmanned aerial vehicle;
a cover removably securable to the base; and
a cargo compartment disposed in a space between the base and the cover at a balance point of the unmanned aerial vehicle,
wherein the cover is removable from the base to provide access to the cargo compartment from a side of the unmanned aerial vehicle opposite from the landing gear; and
one or more electronic components to monitor and control one or more environmental parameters within the cargo compartment.

18. The unmanned aerial vehicle of claim 17, wherein the one or more environmental parameters include at least one of temperature, vibrations, or humidity within the cargo compartment.

19. The unmanned aerial vehicle of claim 17, wherein the one or more electronic components include a communication component configured to transmit information related to the one or more environmental parameters to an external device and to receive information to control the one or more environmental parameters from the external device.

20. The unmanned aerial vehicle of claim 17, wherein the one or more electronic components include a memory configured to store information related to the one or more environmental parameters within the cargo compartment during a flight from an origin to a destination.
